(19) United States
(12) Patent Application Publication
(10) Pub. No.: US 2013/0268582 A1
(43) Pub. Date: Oct. 10, 2013

(54) Method And Apparatus for Distributing Content Among Multiple Devices While In An Offline Mode

(71) Applicant: NOKIA CORPORATION, Espoo (FI)

(72) Inventors: Moses Sitati, Nairobi (KE); Pauline Githinji, Nairobi (KE); Jussi Impio, Nairobi (KE); Marko Myllyluoma, Oulu (FI); Brian Gichana Omwenga, Nairobi (KE); Mwangi Mokeiro Masita, Nairobi (KE); Lucy Macharia, Nairobi (KE); Billy Odero, Nairobi (KE); Nancy Mwakaba, Nairobi (KE); Fredrick Omondi, Nakuru (KE); Juliet Mutahi, Nairobi (KE); Raphael Mutiso, Nairobi (KE); Stephen Gachoka, Mombasa (KE)

(73) Assignee: Nokia Corporation, Espoo (FI)

(21) Appl. No.: 13/856,083

(22) Filed: Apr. 3, 2013

(30) Foreign Application Priority Data
Apr. 5, 2012 (KE) KE/P/2012/001541

(51) Int. Cl. H04L 29/06

(52) U.S. Cl. CPC H04L 67/42
USPC 709/203

(57) ABSTRACT

An example approach is provided for distributing content among user devices while in an offline mode. In the approach, a distributing/requesting module causes determination of one or more requests from at least one requesting device for one or more content items associated with at least one distributing device, wherein the one or more requests are determined using local connectivity between the at least one requesting device and the at least one distributing device. Further, distributing/requesting module causes an exchange, a storage, or a combination thereof of transactional information associated with the one or more requests, a delivery of the one or more content items, or a combination thereof of in an offline mode. Furthermore, the distributing/requesting module causes a transmission of the transactional information to at least one server when in an online mode.

### BACKGROUND

Service providers and device manufacturers (e.g., wireless, cellular, etc.) are continually challenged to deliver value and convenience to consumers by, for example, providing compelling network services. One area of interest has been the development of services and applications that enable users to share with and/or distribute content (e.g., songs, movies, pictures, electronic books, etc.) to other users. However, in developing markets (e.g., China, India, and Africa) Internet access is still challenging and costly. More specifically, many users in these regions may have to rely on content vendors, invest in a computer or an Internet capable device, and utilize slow Internet and/or communication networks in order to obtain and/or distribute content via the Internet. As a result, a majority of users in developing countries have limited access to content that is distributed over the Internet and/or social networking services (e.g., FACEBOOK, TWITTER, etc.). Accordingly, service providers and device manufacturers face significant technical challenges to provide users in emerging markets with the ability to obtain and to distribute content without a need to access a communication network.

### SOME EXAMPLE EMBODIMENTS

Therefore, there is a need for an approach for distributing content among multiple devices while in an offline mode.

According to one embodiment, a method comprises determining one or more requests from at least one requesting device for one or more content items associated with at least one distributing device, wherein the one or more requests are determined using local connectivity between the at least one requesting device and the at least one distributing device. The method also comprises causing, at least in part, an exchange, a storage, or a combination thereof of transactional information associated with (a) the one or more requests, (b) a delivery of the one or more content items, or (c) a combination thereof of in an offline mode. The method further comprises causing, at least in part, a transmission of the transactional information to at least one server when in an online mode.

According to one embodiment, an apparatus comprising at least one processor; and at least one memory including computer program code for one or more programs, the at least one memory and the computer program code configured to, with the at least one processor, cause the apparatus to determine one or more requests from at least one requesting device for one or more content items associated with at least one distributing device, wherein the one or more requests are determined using local connectivity between the at least one requesting device and the at least one distributing device. The apparatus is further caused to cause, at least in part, an exchange, a storage, or a combination thereof of transactional information associated with (a) the one or more requests, (b) a delivery of the one or more content items, or (c) a combination thereof of in an offline mode. Additionally, the apparatus is caused to cause, at least in part, a transmission of the transactional information to at least one server when in an online mode.

According to another embodiment, a computer-readable storage medium carrying one or more sequences of one or more instructions which, when executed by one or more processors, cause, at least in part, an apparatus to determine one or more requests from at least one requesting device for one or more content items associated with at least one distributing device, wherein the one or more requests are determined using local connectivity between the at least one requesting device and the at least one distributing device. The apparatus is further caused to cause, at least in part, an exchange, a storage, or a combination thereof of transactional information associated with (a) the one or more requests, (b) a delivery of the one or more content items, or (c) a combination thereof of in an offline mode. Additionally, the apparatus is caused to cause, at least in part, a transmission of the transactional information to at least one server when in an online mode.

According to another embodiment, an apparatus comprises means for determining one or more requests from at least one requesting device for one or more content items associated with at least one distributing device, wherein the one or more requests are determined using local connectivity between the at least one requesting device and the at least one distributing device. The apparatus also comprises means for causing, at least in part, an exchange, a storage, or a combination thereof of transactional information associated with (a) the one or more requests, (b) a delivery of the one or more content items, or (c) a combination thereof of in an offline mode. The apparatus also comprises means for causing, at least in part, a transmission of the transactional information to at least one server when in an online mode.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of distributing content among multiple devices while in an offline mode, according to one embodiment;

FIG. 2 is a diagram of the components of a distributing and receiving module, according to one embodiment;

FIGS. 3, 4 and 5 are flowcharts of processes for distributing content among multiple devices while in an offline mode, according to various embodiments;

FIG. 6A is a diagram of an example user interface utilized in the processes of FIGS. 3, 4 and 5, according to various embodiments;

FIG. 6B is a diagram of an example of exchange of credits between a distributing and a requesting device, according to one embodiment;

FIG. 6C is a diagram of an example of a transmission of content from one device to another device, according to one embodiment;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for distributing content among multiple devices while in an offline mode are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

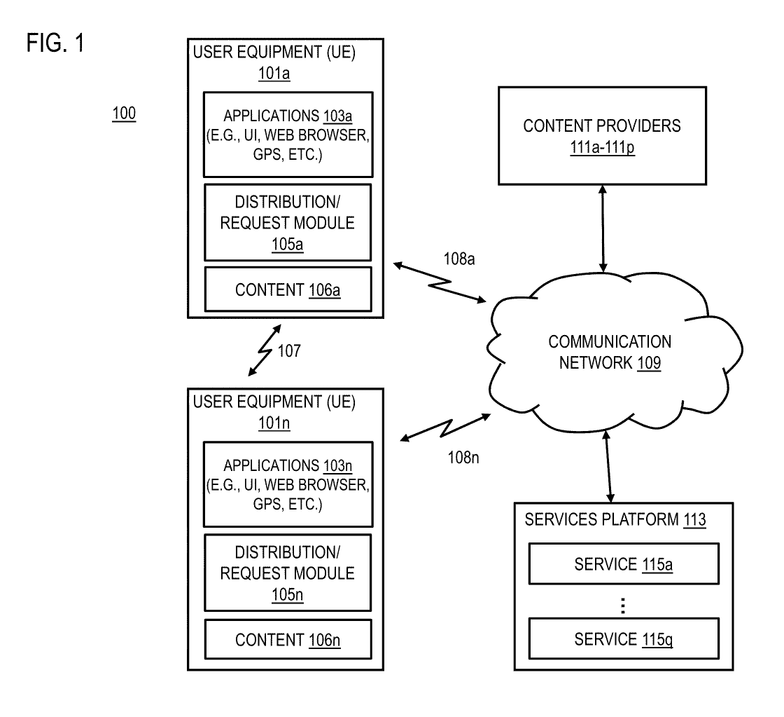

FIG. 1 is a diagram of a system capable of distributing content among multiple devices while in an offline mode, according to one embodiment. As previously discussed, in developing markets (e.g., China, India, and Africa) obtaining Internet access is still a challenge for a majority of users. As a result, the majority of users in these regions have limited access to content (e.g., songs, movies, pictures, electronic books, etc.) that is distributed over the Internet and/or social networking services (e.g., FACEBOOK, TWITTER, etc.). Traditionally, users need to connect to the Internet (e.g., via a network communication link) in order to obtain content from a distributor or from another user willing to share a content item with other users. Similarly, content distributors (e.g., providers, publishers, creators, associated parties, owners, etc.) need the Internet and/or a network communication link in order to distribute to users requesting the content. As discussed above, limitations associated with the Internet such as limited accessibility, cost, user device capability, and the like can limit the potential and advantages of the distribution of the content to a large number of users. However, piracy is a major global issue for digital content publishers/owners as users may copy and distribute content among the user devices (e.g., mobile phones) without paying licensed distributors, originators, publishers, associated parties, owners, and the like of, the content. Further, it may be difficult or impossible for users to become legitimate distributors of content to a larger population of users and be rewarded for enabling the distribution. One root cause of the accessibility issue may be due to fact that e-commerce traditionally has been controlled from a central online distributor (e.g., a content provider, a service provider, etc.), which may not allow users/consumers to further distribute the content to other users (e.g., as limited by copy protection methods and/or legislation). Furthermore, accessing content at a central distribution point requires users to have an online connection (e.g., mobile communication network) as well as incur high transaction fees, which may be prohibitive for micro-purchases by customers in emerging economies and markets.

To address these problems, a system 100 of FIG. 1 introduces the capability to distribute content available on one or more user devices to one or more other user devices without a need for any of the user devices to have an active connection to the Internet or a communication network (e.g., while in an offline mode.) In other words, in a platform for offline commerce, a user device (e.g., a requesting device) may monitor for and connect to one or more other user devices (e.g., distributors) in close proximity, for example, via one or more proximity communication methods (e.g., Bluetooth®, NFC (near filed communication), etc.), request for, and review catalogs/lists of content items available on the one or more other user devices. Further, the user device may request (requesting device) to download one or more available content items from the one or more other user devices in exchange (e.g., purchase) for transfer of one or more credit points to the distributing device wherein the credit points may be online points, monetary points (e.g., available in an account), gaming points, and the like. More specifically, in one use case scenario, a device “A” monitors for other nearby user devices (e.g., via Bluetooth®, NFC, etc.), for example a device “B” and a device “C,” and requests and/or receives one or more catalogs of content items available for purchase on those other user devices. Next, user of the device “A” may select a content item available for purchase on the device “B” and upon acceptance of possible terms and conditions by the users of device “A” and/or “B”, one or more client applications on the user device “A” and/or “B” cause a download/upload of the selected content item from device “B” to device “A”. Further, prior to completion of the download, the client applications exchange payment data (e.g., credit points, monetary points, etc.) via the close proximity connection (e.g., Bluetooth®, NFC, IrDA™, etc.) and then transmit to a server (e.g., at a service provider) one or more transaction records associated the purchase of the content item whereby the payment (e.g., credit points, monetary points, etc.) may be divided and awarded to one or more distributors (e.g., device “B”), associated parties, publishers, owners, originators and the like, who may be associated with the content item distributed to the device “A”.

As discussed above, utilizing such a distribution platform can, at least, provide advantages to users by allowing the users to obtain content while in an offline mode; allow multiple users to legitimately (e.g., with licensing rights) distribute content and be rewarded for it; and provide to content publishers, associated parties, owners, originators, and the like a wider network of distributors and additional proceeds that otherwise may have been lost.

In one embodiment, a distributing device may receive one or more requests from at least one requesting device for one or more content items associated with at least one distributing device, wherein the one or more requests are determined using local connectivity between the at least one requesting device and the at least one distributing device. For example, the system 100 may cause a rendering of at least one user interface (e.g., a graphical user interface (GUI)) in at least one content distributing device and/or in at least one requesting device to enable distribution and/or reception of one or more of content items (e.g., songs, movies, pictures, electronic books, mobile applications, etc.), wherein the at least one distributing device and the at least one requesting device utilize one or more local communication channels (e.g., via Bluetooth®, NFC, etc.) to communicate information related to the one or more requests and/or to the one or more content items. In one embodiment, the system 100 can enable the at least one distributing device to distribute/broadcast one or more catalogs/lists of its content available for purchase to one or more other user devices (e.g., the at least one requesting device). In another embodiment, one or more user devices (e.g., the at least one requesting device) can request one or more catalogs/lists of content available in one or more other user devices (e.g., the at least one distributing device). In various embodiments, the at least one distributing device may download, receive, record, and the like, one or more content items from one or more content providers.

In various embodiments, the at least one distributing device, the at least one requesting device, and/or a network server cause, at least in part, an exchange, a storage, or a combination thereof of transactional information associated with (a) the one or more requests, (b) a delivery of the one or more content items, or (c) a combination thereof of in an offline mode. For example, the at least one distributing device, the at least one requesting device and/or a local network component (e.g., a local hub/server available to the at least one content distributing device and/or to the at least one requesting device via a proximity communication channel (e.g., Bluetooth®) can store at a local storage, respectively, transactional information (e.g., content, date, location, distributing device, requesting device, content price, download/upload status, etc.) related to one or more transactions between the at least one distributing device and the at least one requesting device. In another example, the transactional information comprises information related to delivery of the one or more content items such as the delivered content items, the at least one requesting device and, one or more account information (e.g., bank account, credit account, online gaming account, etc.) related to the at least one requesting device, delivery date, delivery method (e.g., via NFC), delivery location, delivered content, transaction purchase amount (e.g., credits, points, etc.) and the like. It is noted that the at least one requesting device and the at least one distributing device do not necessarily need to be co-located so long as they can establish and maintain a communication session via the proximity communication channel. Also, the users of the at least one requesting device and the at least one distributing device do not necessarily need to communicate with one another in person in order to distribute, request, purchase, make a payment and the like so long as their devices can establish and maintain the communication session in order to complete a transaction.

In one embodiment, the distributing device causes, at least in part, a transmission of the transactional information to at least one server when in an online mode. In one embodiment, the at least one content distributing device, the at least one requesting device and/or the local network component cause, at least in part, a transmission (e.g., via a network communication channel, Internet, etc.) of the transactional information to a network server (e.g., a content provider server) when in an online mode (e.g., connected to a communication network, Internet, etc.)

In various embodiments, the system 100 can cause the at least one distributing device and/or the at least one requesting device to discover at least one requesting device, at least one distributing device, or a combination thereof over one or more proximity communication methods. For example, a requesting user device can monitor and/or search for other nearby devices over a proximity communication channel (e.g., Bluetooth®, NFC).

In one embodiment, the system 100 causes, at least in part, a compilation of one or more catalogs of the one or more content items available from the at least one distributing device. For example, a distributing device can create/compile a catalog of its content which may include content information related to the types of content, availability of the content, purchase price, restrictions, and the like, wherein the one or more content items may be acquired from one or more content providers, service providers, distributors, and the like.

In another embodiment, the system 100 causes, at least in part, a transmission of the one or more catalogs to the at least one requesting device in response to the one or more requests. For example, a distributing device can broadcast information associated with its content, its user device information, and method of contact to one or more requesting devices in response to one or more requests from the one or more requesting devices whereby the one or more requesting devices may browse the one or more catalogs. In another embodiment, the at least one distributing device can transmit the one or more catalogs before receiving a request from the at least one requesting device (e.g., broadcast).

In various embodiments, the system 100 processes and/or facilitates a processing of metadata associated with the one or more content items to determine one or more associated parties (e.g., owners) of the one or more content items. For example, a content provider may include or separately transmit metadata along with one or more content items to one or more devices (e.g., at least one distributing device) such that the one or more devices can determine one or more associated parties, owners, publishers, distributors, originators, and the like, associated with the one or more content items.

In various embodiments, the system 100 processes and/or facilitates a processing of the transactional information to cause, at least in part, distribution of one or more credits, one or more debits, or a combination thereof among the one or more associated parties, the at least one requesting device, the at least one distributing device, or a combination thereof. For example, the transactional information may indicate that at least one requesting device received one or more content items for a specified number of debit points (e.g., per each content item, for entire transaction, etc.) wherein the specified number of points may be credited to one or more accounts of one or more distributors and/or one or more associated parties wherein the one or more associated parties may comprise one or more parties who may have one or more controlling rights and/or interests associated with the one or more content items.

In various embodiments, the systems 100 can process metadata associated with the one or more content items to determine rights management information (RMI), wherein the transactional information, the delivery of the one or more content items, or a combination thereof are based, at least in part, on the RMI. For example, the metadata can indicate RMI and/or digital rights management (DRM) policies/rules associated with the one or more contents, which may, for example, indicate one or more rules on utilization, distribution, advertising, sale, purchase, delivery, required transaction information, and the like.

In various embodiments, the system 100 causes, at least in part, a registration of the one or more content items with at least one content provider, wherein the metadata, the rights management information, or a combination thereof are determined from the at least one content provider. In one example, a content owner (e.g., publisher, producer, originator, etc.) can register the one or more content items with a content provider service (e.g., a music content provider) wherein one or more RMI items (e.g., rules/policies) are associated with the one or more content items. In one embodiment, the content provider determines the one or more RMI items. In another embodiment, one or more parties (e.g., publisher, producer, originator, etc.) associated with the one or more content items determine the RMI items.

In one embodiment, the RMI is based, at least in part, on one or more encryption schemes, one or more activation keys, or a combination thereof. For example, a content provider may determine and associate the RMI with an encryption and/or an activation key with one or more content items so that subsequent actions on the one or more content items, for example; distribution, use, sharing, selling, and the like; may be controlled by the defined RMI. In one example, a user may need an activation key before consumption of a content item can proceed. In another example, a distributing device may need an encryption key for a content item before the content item can be distributed to another user.

In various embodiments, the system 100 causes, at least in part, a ranking of the at least one distributing device based, at least in part, on a number of times that the at least one distributing device has distributed the one or more content items to the at least one requesting device, one or more other devices, or a combination thereof. For example, a content provider may associate one or more ranking information items with a distributing device based on, at least in part, a frequency of distribution by the distributing device, types of content distributed, location of one or more distributions, one or more rankings by users of requesting devices, and the like.

In various embodiments, the system 100 causes, at least in part, the transmission of the transactional information based, at least in part, on an availability of the online mode, a predetermined schedule, on demand, or a combination thereof. For example, a distributing device and/or a requesting device may locally store one or more transactional information (e.g., content, time, date, price, distributor, requestor, etc.) and later transmit the transactional information to a service provider (e.g., a content provider) once the distributing device and/or the requesting device have access to a communication network (e.g., wireless mobile service, WLAN service, etc.) wherein the transmission may be done at a predetermined schedule, on demand and the like.

In various embodiments, the system 100 processes and/or facilitates a processing of the transactional information to determine at least one distribution path for the one or more content items. For example, the at least one requesting device, the at least one distributing device, a network server and/or a content provider may report, collect, store, request, and/or determine one or more information items independently and/or from the transaction information in order to determine one or more distribution paths associated with one or more content items. In one example, a content provider tracks transactional information associated with a specific content item in order to determine a distributing device with most transactions, which include the specific content item. In another example, the content provider may wish to track all distributing devices which have distributed a specific content item. In one embodiment, the distribution path associated with the one or more content items may be made available to one or more distributing and/or requesting devices, one or more service providers, one or more parties associated with the one or more content items, and the like.

As shown in FIG. 1, the system 100 comprises one or more user (UE) 101a-101n (e.g., a mobile phone) (also collectively referred to as UEs 101) which may be utilized to execute applications 103a-103n (e.g., a social networking application, a web browser, a media application, user interface, GPS, a mapping application, a web client, etc.) (also collectively referred to as applications 103) to access 108a-108n one or more available online services at a services 115a-115q (also collectively referred to as services 115) and/or one or more content providers 111a-111p (also collectively referred to as content providers 111) over a communication network 109. The services 115 may comprise one or more services, for example, financial services, social networking services, online shopping, media upload, media download, media streaming, account management services, or a combination thereof. The content providers 111 may provide to the UEs 101 and/or to the services platform 113 a range of content items such as songs, movies, pictures, electronic books, mobile applications, and the like. In one embodiment, the UEs 101 may also communicate with each other via one or more proximity wireless connections 107 (e.g., Bluetooth®, NFC, etc.) and utilize distribution/request modules 105a-105n (also collectively referred to as distribution/request (D/R) module 105) to distribute one or more content 106a-106n (also collectively referred to as content 106) from one or more UEs 101 to one or more other UEs 101.

In one embodiment, the D/R module 105 is capable of substantially simultaneously transmitting and receiving one or more content items to and/or from one or more devices.

In one embodiment, the D/R module 105 causes a rendering of at least one user interface (e.g., a GUI) at the UEs 101 to enable the requesting and/or distribution of one or more content 106 (e.g., songs, movies, pictures, electronic books, mobile applications, etc.) among the UEs 101 (e.g., mobile phones) having connectivity via one or more proximity wireless communication channels. In one embodiment, the one or more content 106 are made available by the content providers 111 (e.g., a mobile application store), the services platform 113 (e.g., one or more social networking services), or a combination thereof and can be stored locally at the UEs 101 for later distribution to other UEs 101. In one example use case, a UE 101 monitors a proximity wireless communication channel (e.g., Bluetooth®) for other UEs 101; discovers at least one other UE 101; makes a wireless connection to the other UE 101 via a wireless connection channel (e.g., Bluetooth®, NFC); requests a catalog of the content 106 available for purchase at the other UE 101; selects one or more content items from the catalog; negotiates an exchange of credits/points with the other UE 101, and downloads the one or more content items via a wireless communication channel (e.g., Bluetooth®, NFC, IrDA) from the other UE 101 as agreed in the negotiation with the other UE 101.

In one embodiment, a user “A” converts some money into credit points by making a cash deposit into a service provider controlled account with a financial agent. Then, the user “A” wallet in a mobile client on user “A” UE 101 is synchronized (via online communication) with information from the financial agent to reflect the deposited money and equivalent points in the user “A” account. Further, an account management log is maintained and monitored by a central server to update debit and credit points to the account and once the wallet is updated with the credit points, the user “A” may make purchases from user “B” who is participating in the offline distribution system. When making an offline transaction, user “A” wallet will cause a transfer of appropriate number of points from user “A” wallet to user “B”s wallet (via Bluetooth or other wireless communication) in exchange for content and/or service from the user B device, wherein the user “A” point-balance in his wallet will reduce while the user “B” point-balance will increase. In one embodiment, user B receives points and not actual currency. A transaction information log is created and stored by the client application at the requesting and/or distributing devices which comprises time, date, user/device ID, exchanged points, content requested, content delivered, original content owner ID, and the like.

In one embodiment, each D/R module 105 (e.g., platform client application) owns key pairs which are issued one-time by a central server (e.g., content providers 111, services platform 113). A device “A” (requesting device) requests content from a device “B” (distributing device) wherein the distributing device is able to read the requesting device public key from a, for example, Bluetooth® Service Discovery Database (SDDB). Further, the distributing device D/R module 105 generates a rights management key for one or more requested content items based on transactional information exchanged between the requesting and distributing devices. Furthermore, rights management key is then embedded/associated with one or more content items wherein the distributing D/R module 105 then dynamically generates a one-time symmetric activation key for the one or more content items. Next, the one or more content items and the rights management key are encrypted using the generated activation key wherein the activation key is then encrypted using the requesting device public key and signed using distributing device private key are then delivered to the requesting device.

In another embodiment, the requesting device receives the encrypted content items and verifies a source of the content and confirms that the content is from a valid platform application client using the distributing device public key. Further, the encrypted activation key is decrypted utilizing the distributing device private key and the activation key is utilized to decrypt the one or more content items. By decrypting the content file, the requesting device D/R module 105 activates the rights management key and gains access to the content items.

In various embodiments, based on one or more predefined criteria, the requesting and/or distributing client applications are triggered to report transaction information details to a central server (e.g., at a service platform). For example, a transaction report is transmitted when reaching a certain number of offline transactions, receiving a certain value of transactions, a certain content item is delivered, based on date, and the like. In one embodiment, a communication session (e.g., an http session) is established between a central server and the D/R module at a distributing and/or a requesting device wherein the transaction report may include one or more, transaction identifications (IDs), user IDs, and Content IDs, and the like. Further, once the transaction reporting is complete, the central server updates one or more user records and executes one online transactions crediting and debiting one or more accounts associated with one or more distributors, requestors, associated parties, owners, and the like. This online event triggered by offline activity is useful especially for merging several micro-transactions into one online update realizing an advantage of reduced transaction costs attributed to each transaction.

By way of example, the communication network 109 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UEs 101, the content providers 111, and the services platform 113 communicate with each other and other components of the communication network 109 using well known, new or still developing protocols. In this context, a protocol includes a set of rules defining how the network nodes within the communication network 109 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

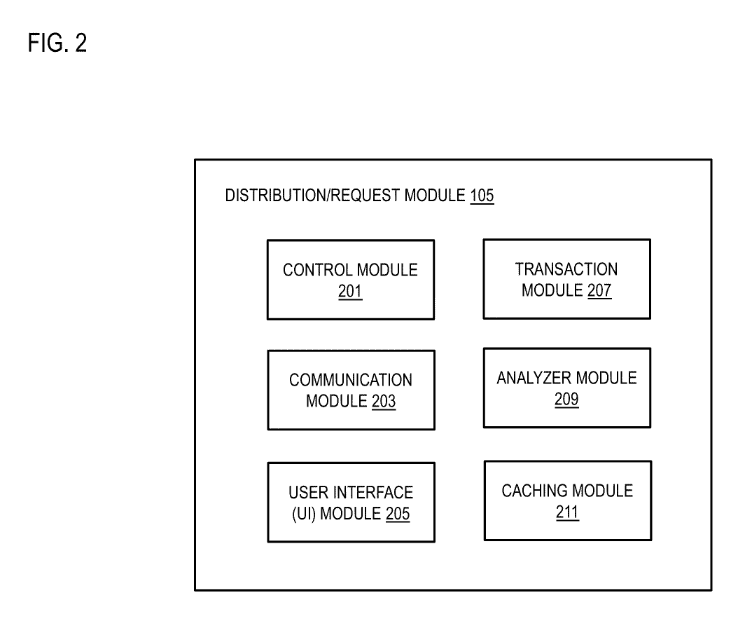

FIG. 2 is a diagram of the components of the distributing and receiving (D/R) module 105, according to one embodiment. By way of example, the D/R module 105 includes one or more components for distributing to and/or receiving content from multiple devices while the devices are in an offline mode. It is contemplated that the functions of these components may be combined in one or more components or performed by other components of equivalent functionality. In one embodiment, the D/R module 105 includes a control module 201, a communication module 203, a user interface (UI) module 205, a transaction module 207, an analyzer module 209, and a caching module 211.

In one embodiment, the control module 201 executes at least one algorithm for executing functions of the D/R module 105. For example, the control module 201 may execute an algorithm for processing one or more interactions among multiple UEs 101 in order to distribute and/or receive one or more content items (e.g., songs, movies, pictures, electronic books, mobile applications, homework assignments, etc.) among the multiple UEs 101 (e.g., mobile phones) via one or more proximity wireless communication channels (e.g., Bluetooth®, NFC, etc.). By way of another example, the control module 201 may execute an algorithm to interact with the communication module 203 to communicate among the one or more UEs 101, the D/R module 105, the content providers 111, and the services platform 113. The control module 201 also may execute an algorithm to interact with the user interface (UI) module 205 to render at least one user interface (e.g., a GUI) at a UE 101 for distributing and/or receiving one or more content items from the one or more UEs 101 with connectivity to each other. The control module 201 may also execute an algorithm to interact with the transaction module 207 to cause recording/logging of one or more transactions between the one or more UEs 101, the content providers 111, and the services platform 113. Further, the transaction module 207 may also cause reporting of one or more transactional information items (e.g., content items, date, location, distributing device, requesting device, content price, download/upload status, etc.) to the content providers 111, services platform 113 and/or to one or more network components (e.g., a local hub/server). The control module 201 may also execute an algorithm to interact with the analyzer module 209 to determine one or more interactions with one or more UEs 101, to cause a an analysis of one or more requests received from at least one requesting receive and/or a distribution of one or more content 106 to the at least one requesting device. Further, the control module 201 may also execute an algorithm to interact with the caching module 211 to cause a caching of the one or more content 106, one or more content items from the content providers 111 and/or from the services platform 113, one or more transactional information items, or a combination thereof. Furthermore, the control module 201 may execute one or more algorithms to encrypt, decrypt, encode, decode, and/or to determine and transmit one or more RMI and/or DRM associated with the one or more content items transmitted to and/or received from one or more UEs 101.

The communication module 203 is used for communication between the UEs 101, the D/R module 105, the content providers 111, and the services platform 113. Further, the communication module 203 also may be used to communicate commands, requests, data, transactional information, etc. Furthermore, the communication module 203 may also be used to cause a transfer of one or more content 106 to the at least one requesting device and/or to one of the one or more UEs 101. More specifically, the communication module 203 may be used in connection with the one or more wireless communication channels (e.g., Bluetooth®, NFC, etc.), or a combination thereof. In one embodiment, the D/R module 105 may utilize the communication module 203, in connection with the content 106 and/or the caching module 211, to cause a distribution of the one or more content 106 from one or more UEs 101 to one or more other UEs 101.

The user interface (UI) module 205 is used to cause a rendering of at least one user interface (e.g., a GUI) at one or more UEs 101 for distributing one or more content 106 (e.g., songs, movies, pictures, electronic books, mobile applications, etc.) among the and one or more UEs 101 with connectivity to at the at least one distributing device. The user interface module 205, in connection with the analyzer module 209, may also be used to render status information associated with one or more content rights management settings, the one or more UEs 101, one or more requests, a transactional information associated with one or more UEs and/or one or more content items, one or more distribution paths associated with one or more UEs 101 and/or one or more content items, or a combination thereof. Further, the user interface module 205, in connection with the analyzer module 209, may also be used to process the one or more interactions to determine a selection of one or more content 106, one or more credit and/or debit points associated with a transaction, or a combination thereof. The user interface module 205 also may be used to render one or more information items associated with one or more content 106 (e.g., price, artist, publisher, owner, size of file, ranking, etc.), one or more previews (e.g., a one minute sample), or a combination thereof.

The analyzer module 209 may also analyze and determine one or more communication channels available for delivering and/or receiving the one or more content 106 to and/or form one or more UEs 101. For example, one communication channel (e.g., Bluetooth) may be utilized to discover the at least one distributing and/or requesting device and another communication channel (e.g., WLAN) may be utilized to transmit and/or receive the one or more content 106. Further, the analyzer module 209 may also analyze/manage the content items of content 106, for example, create and maintain a current catalog/inventory, associate one or more RMI/DRM rules with the content items, cause a request for additional content items, determining applicable restrictions (e.g., age restricted) associated with the content items, and the like.

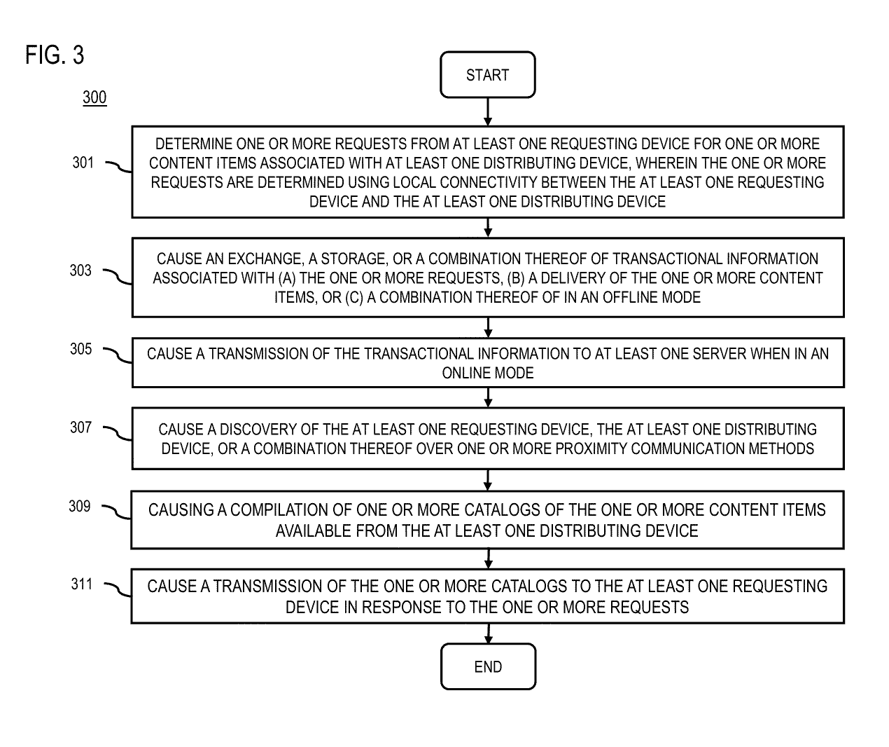

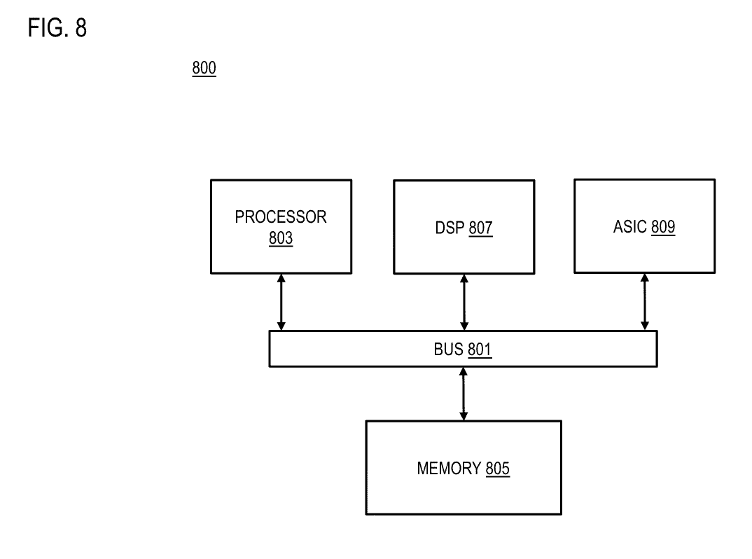

FIG. 3 is a flowchart of a process 300 for distributing content among multiple devices (e.g., mobile phones), according to one embodiment. In various embodiments, the control module 201, the distributing/requesting (D/R) module and/or the services platform 113 perform all or parts of the process 300 and are implemented in, for instance, a chip set including a processor and a memory as shown FIG. 8. In certain embodiments, the services platform 113 may perform some or all of the steps of the process 300 and communicate with the UEs 101 using a client server interface. For example, the UEs 101 may activate the D/R module 105 for requesting and executing one or more transactions at the services platform 113 and/or at the content providers 111. Moreover, the applications 103 may execute upon the control module 201.

In step 301, the D/R module 105 of a UE 101 determines one or more requests from at least one requesting device for one or more content items associated with at least one distributing device, wherein the one or more requests are determined using local connectivity between the at least one requesting device and the at least one distributing device. For example, the D/R module 105 and/or applications 103 may cause a rendering of at least one user interface (e.g., a graphical user interface (GUI)) in at least one content distributing device and/or in at least one requesting device to enable distribution and/or reception of one or more of content items (e.g., songs, movies, pictures, electronic books, mobile applications, etc.), wherein the at least one distributing device and the at least one requesting device utilize one or more local communication channels (e.g., via Bluetooth®, NFC, etc.) to communicate information related to the one or more requests and/or to the one or more content items. In one embodiment, the at least one distributing device is capable of distributing/broadcasting one or more catalogs/lists of its content items available for purchase to one or more other user devices (e.g., the at least one requesting device). In another embodiment, one or more user devices (e.g., the at least one requesting device) can request one or more catalogs/lists of content available in one or more other user devices (e.g., the at least one distributing device). In various embodiments, the at least one distributing device may download, receive, record, and the like, one or more content items from content providers 111.

In step 303, the D/R module 105 in the at least one distributing device, the at least one requesting device, and/or a network server (e.g., at the services platform 113) cause, at least in part, an exchange, a storage, or a combination thereof of transactional information associated with (a) the one or more requests, (b) a delivery of the one or more content items, or (c) a combination thereof of in an offline mode. For example, the at least one distributing device, the at least one requesting device and/or a local network component (e.g., a local hub available to the at least one content distributing device and/or to the at least one requesting device via a proximity communication channel (e.g., Bluetooth®)) can store at a local storage, respectively, transactional information (e.g., content, date, location, distributing device, requesting device, content price, download/upload status, etc.) related to one or more transactions between the at least one distributing device and the at least one requesting device. In another example, the transactional information comprises information related to delivery of the one or more content items such as the delivered content items, the at least one requesting device, one or more account information (e.g., bank account, credit account, online gaming account, etc.) related to the at least one requesting device, delivery date, delivery method (e.g., via NFC), delivery location, delivered content, transaction purchase amount (e.g., credits, points, etc.) and the like. It is noted that the at least one requesting device and the at least one distributing device do not necessarily need to be co-located so long as they can establish and maintain a communication session via the proximity communication channel. Also, the users of the at least one requesting device and the at least one distributing device do not necessarily need to communicate with one another in person in order to distribute, request, purchase, make a payment, and the like, so long as their devices can establish and maintain the communication session in order to complete a transaction.

In step 305, the D/R module 105 causes, at least in part, a transmission of the transactional information to at least one server when in an online mode. In one embodiment, the at least one content distributing device, the at least one requesting device and/or the local network component cause, at least in part, a transmission (e.g., via the communication network 109) of the transactional information to a network server (e.g., at the content providers 111, at the services platform 113, etc.) when in an online mode (e.g., connected to the communication network 109, Internet, etc.)

In step 307, the D/R module 105 causes, at least in part, a discovery of the at least one requesting device, the at least one distributing device, or a combination thereof over one or more proximity communication methods. For example, a requesting device can monitor and/or search for other nearby devices over a proximity communication channel (e.g., via Bluetooth®, NFC).

In step 309, the D/R module 105 causes, at least in part, a compilation of one or more catalogs of the one or more content items available from the at least one distributing device. For example, the D/R module 105 on the at least one distributing device can interface with applications 103 to create/compile a catalog of content 106 which may include content information related to the types of content, availability of the content, purchase price, restrictions, and the like, wherein the one or more content items may have been acquired from the content providers 111, the services platform 113, one or more distributors, and the like.

In step 311, the D/R module 105 causes, at least in part, a transmission of the one or more catalogs to the at least one requesting device in response to the one or more requests. For example, a distributing device can broadcast information associated with its content, its user device information, and method of contact to one or more requesting devices in response to one or more requests from the one or more requesting devices whereby the one or more requesting devices may browse the one or more catalogs. In another embodiment, the at least one distributing device can transmit the one or more catalogs before receiving a request from the at least one requesting device (e.g., broadcast).

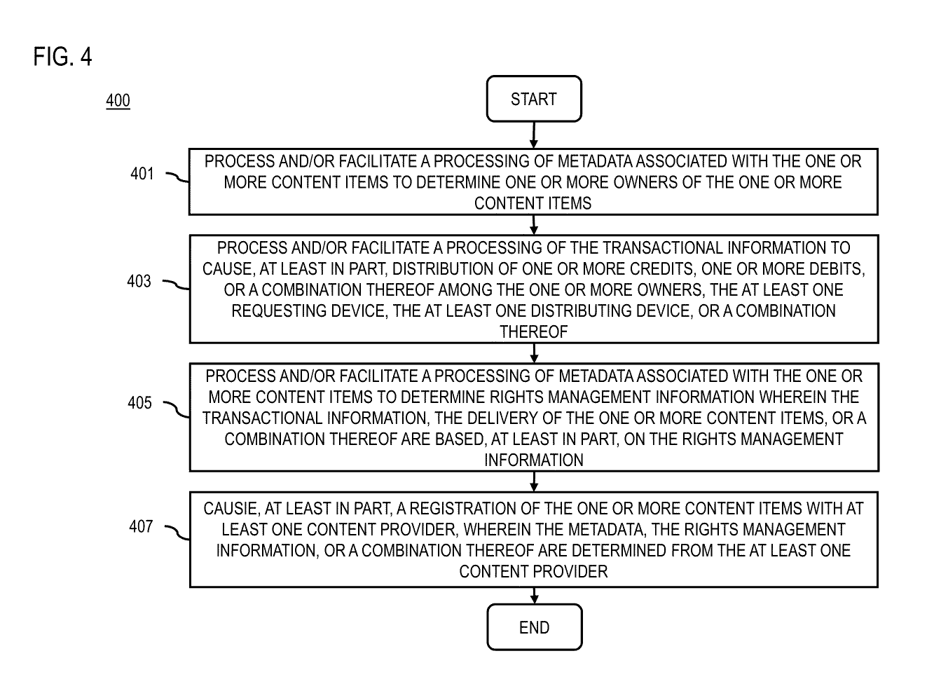

FIG. 4 is a flowchart of a process 400 for processing and managing metadata, transactional information, and registration information associated with one or more content items, according to one embodiment. In various embodiments, the control module 201, the distributing/requesting (D/R) module, and/or the services platform 113 perform all or parts of the process 400 and are implemented in, for instance, a chip set including a processor and a memory as shown FIG. 8. In certain embodiments, the services platform 113 may perform some or all of the steps of the process 300 and communicate with the UEs 101 using a client server interface. For example, the UEs 101 may activate the D/R module 105 and/or applications 103 for analyzing and processing the metadata. Moreover, the applications 103 may execute upon the control module 201.

In step 401, the D/R module 105 processes and/or facilitates a processing of metadata associated with the one or more content items to determine one or more associated parties of the one or more content items. For example, a content provider may include and/or separately transmit metadata along with one or more content items to one or more devices (e.g., at least one distributing device) such that the one or more devices can determine one or more associated parties, publishers, distributors, originators, owners, and the like, associated with the one or more content items.

In step 403, the D/R module 105 and processes and/or facilitates a processing of the transactional information to cause, at least in part, distribution of one or more credits, one or more debits, or a combination thereof among the one or more associated parties, the at least one requesting device, the at least one distributing device, or a combination thereof. For example, the transactional information may indicate that at least one requesting device received one or more content items for a specified number of debit points (e.g., per each content item, for entire transaction, etc.) wherein the specified number of points may be credited to one or more accounts of one or more distributors and/or one or more associated parties wherein the one or more associated parties may comprise one or more parties who may have one or more controlling rights and/or interests associated with the one or more content items.

In step 405, the D/R module 105 processes and/or facilitates a processing of metadata associated with the one or more content items to determine rights management information, wherein the transactional information, the delivery of the one or more content items, or a combination thereof are based, at least in part, on the rights management information. For example, the metadata can indicate RMI and/or digital rights management (DRM) policies/rules associated with the one or more contents, which may, for example, indicate one or more rules on utilization, distribution, advertising, sale, purchase, delivery, required transaction information, and the like.

In step 407, the D/R module 105 causes, at least in part, a registration of the one or more content items with at least one content provider, wherein the metadata, the rights management information, or a combination thereof are determined from the at least one content provider. In one example, a content owner (e.g., publisher, producer, originator, etc.) can register the one or more content items with a content provider service (e.g., a music content provider) wherein one or more RMI items (e.g., rules/policies) are associated with the one or more content items. In one embodiment, the content provider determines the one or more RMI items. In another embodiment, one or more parties (e.g., publisher, producer, originator, etc.) associated with the one or more content items determine the RMI items. In one embodiment, the RMI is based, at least in part, on one or more encryption schemes, one or more activation keys, or a combination thereof. For example, a content provider may determine and associate the RMI with an encryption and/or an activation key with one or more content items so that subsequent actions on the one or more content items, for example; distribution, use, sharing, selling, and the like; may be controlled by the defined RMI. In one example, a user may need an activation key before consumption of a content item can proceed. In another example, a distributing device may need an encryption key for a content item before the content item can be distributed to another user.

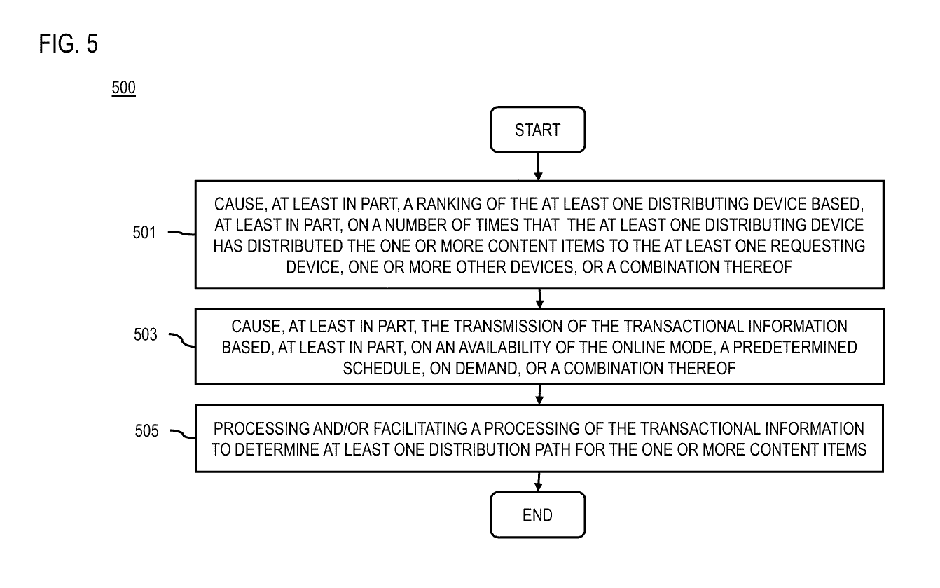

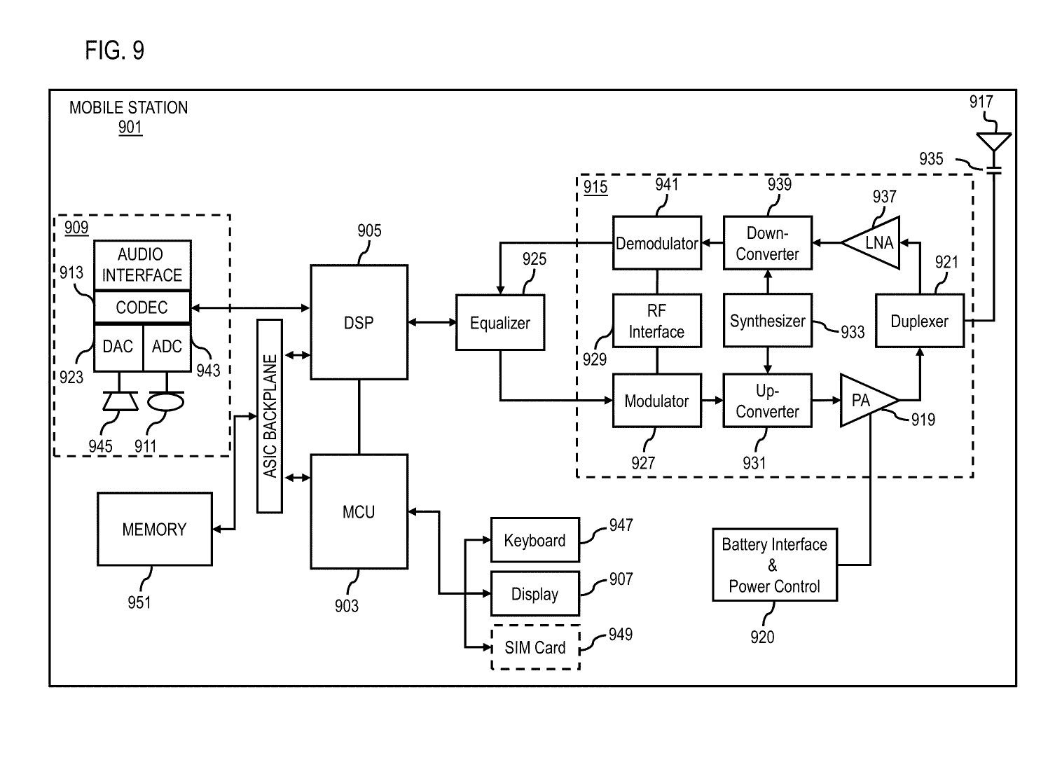

FIG. 5 is a flowchart of a process 500 for ranking, reporting and tracking one or more information items associate with one or more distributors, transactions and/or content items, according to various embodiments. In various embodiments, the control module 201, the distributing/requesting (D/R) module, and/or the services platform 113 perform all or parts of the process 300 and are implemented in, for instance, a chip set including a processor and a memory as shown FIG. 9. In certain embodiments, the services platform 113 may perform some or all of the steps of the process 300 and communicate with the UEs 101 using a client server interface. For example, the UEs 101 may activate the D/R module 105 and/or applications 103 for reporting transactional information to a central server (e.g., at the services platform 113) according to one or more criteria. Moreover, the applications 103 may execute upon the control module 201.

In step 501, the D/R module 105 and/or the services platform 113 cause, at least in part, a ranking of the at least one distributing device based, at least in part, on a number of times that the at least one distributing device has distributed the one or more content items to the at least one requesting device, one or more other devices, or a combination thereof. For example, a content provider may associate one or more ranking information items with a distributing device based on, at least in part, a frequency of distribution by the distributing device, types of content distributed, location of one or more distributions, one or more rankings by users of requesting devices, and the like.

In step 503, the D/R module 105 causes, at least in part, the transmission of the transactional information based, at least in part, on an availability of the online mode, a predetermined schedule, on demand, or a combination thereof. For example, a distributing device and/or a requesting device may locally store one or more transactional information (e.g., content, time, date, price, distributor, requestor, etc.) and later transmit the transactional information to a service provider (e.g., a content provider) once the distributing device and/or the requesting device have access to a communication network (e.g., wireless mobile service, WLAN service, etc.) wherein the transmission may be done at a predetermined schedule, on demand and the like.

In step 505, the D/R module 105 and/or the services processing and/or facilitating a processing of the transactional information to determine at least one distribution path for the one or more content items. For example, the at least one requesting device, the at least one distributing device, a network server and/or a content provider may report, collect, store, request, and/or determine one or more information items independently and/or from the transaction information in order to determine one or more distribution paths associated with one or more content items. In one example, a content provider tracks transactional information associated with a specific content item in order to determine a distributing device with most transactions, which include the specific content item. In another example, the content provider may wish to track all distributing devices which have distributed a specific content item. In one embodiment, the distribution path associated with the one or more content items may be made available to one or more distributing and/or requesting devices, one or more service providers, one or more parties associated with the one or more content items, and the like.

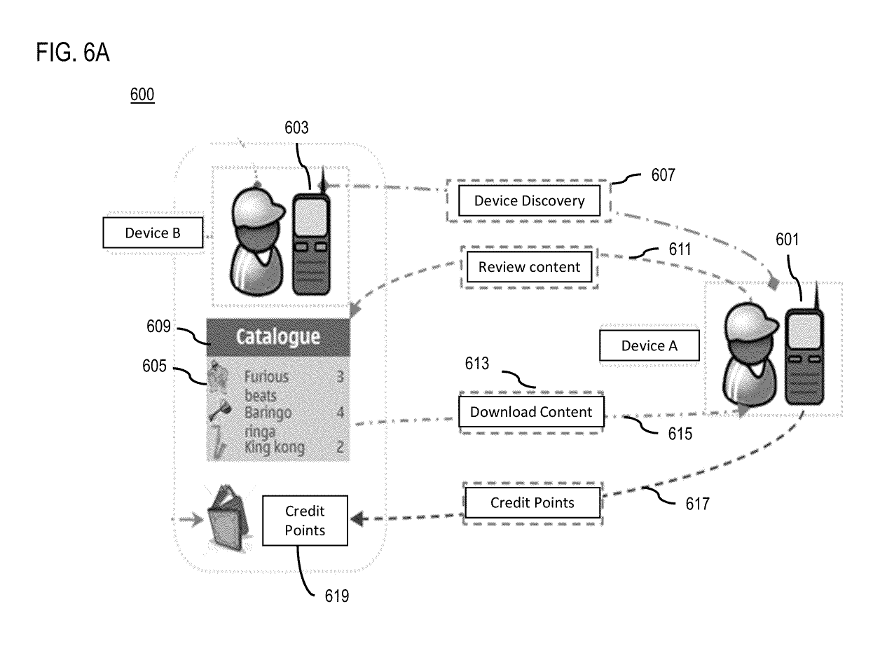

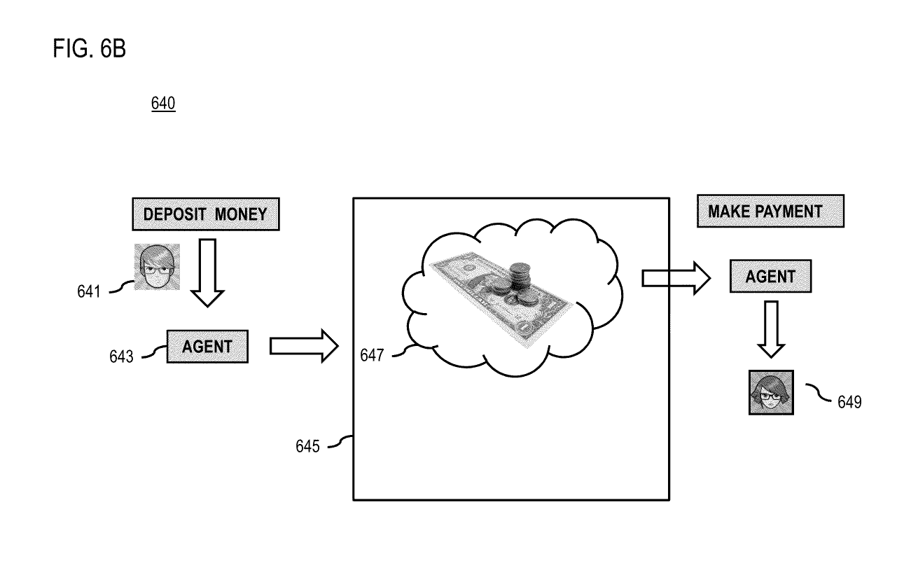

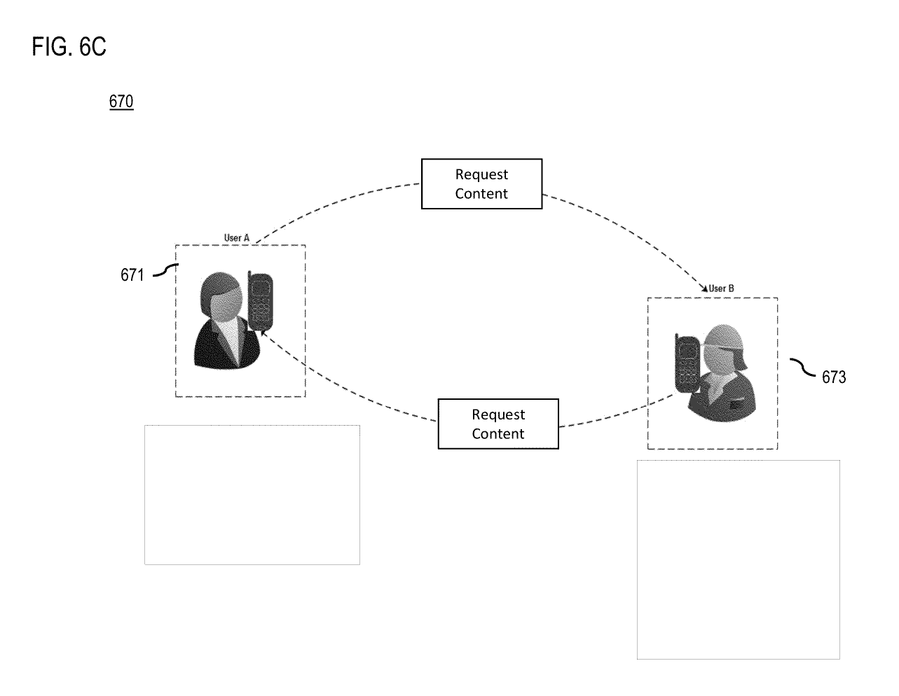

FIG. 6A is diagram 600 of an example of one or more mobile devices utilized in the processes of FIGS. 3, 4 and 5, according to one embodiment. More specifically, FIG. 6A depicts at least two devices 601 (device “A”) and 603 (device “B”) (e.g., a mobile phone) having at least one user interface 605 (e.g., a GUI) for distributing one or more content items (e.g., songs, movies, pictures, electronic books, mobile applications, etc.) from one or more devices (e.g., distributing devices) to one or more other devices (e.g., requesting devices). In one example, the device “A” monitors at least one proximity wireless communication channel (e.g., Bluetooth®, NFC, etc.) 607 to search for other devices such as device “B” 603. Once device “B” is discovered, device “A” and device “B” establish at least one wireless connection between devices “A” and “B” via the wireless communication channel 607. Furthermore, the device “A” requests a catalog 609 of one or more content items available for purchase the device “B” and reviews the one or more contents 605 via a different communication channel 611 or the same communication channel as in 607. Next, the device “A” selects one or more content items from the catalog 609, negotiates an exchange of credits/points 617 into at least one account 619 associated with the device “B”, and downloads the one or more negotiated content items 613 via at least one wireless communication channel 615, 607 and/or 611 (e.g., Bluetooth®, NFC, IrDA).

FIG. 6B is diagram 640 of an example of exchange of credits between a distributing and a requesting device, according to one embodiment. In one embodiment, a user 641 converts some money into credit points by making a cash deposit into a service provider controlled account with a financial agent 643. Then, the user 641 account (e.g., mobile wallet) 645 is synchronized (via online communication) with information from the financial agent to reflect the deposited money 647 and/or equivalent points in the user 641 account. Further, an account management log is maintained and monitored by a central server to update debit and credit points to the account and once the account is updated with the credit points, the user 641 may make purchases from user 649 who is participating in the offline distribution system. When making an offline transaction, the user 641 account will cause a transfer of appropriate number of points from the user 641 account to the user 649 account (e.g., via Bluetooth or other wireless communication channels) in exchange for content and/or service from the user 649 device, wherein the user 641 point-balance in his account will reduce while the user 649 point-balance will increase. In one embodiment, user 649 receives points and not actual currency. A transaction information log is created and stored by the client application at the requesting and/or distributing devices which comprises time, date, user/device ID, exchanged points, content requested, content delivered, original content owner ID, and the like.

FIG. 6C is diagram 670 of an example of a transmission of content from one device to another device, according to one embodiment. In one embodiment, each D/R module 105 (e.g., platform client) in device 671 and device 673 owns a pair of keys, which are issued one-time by a central server (e.g., content providers 111, services platform 113). The device 671 (user “A”) (requesting device) requests content from the device 673 (user “B”) (distributing device) wherein the distributing device is able to read the requesting device public key from a, for example, Bluetooth® Service Discovery Database (SDDB). Further, the distributing device 673 D/R module 105 generates a rights management key for one or more requested content items based on transactional information exchanged between the requesting 671 and distributing 673 devices. Furthermore, a rights management key is then embedded/associated with the one or more content items, wherein the distributing 673 device D/R module 105 then dynamically generates a one-time symmetric activation key for the one or more content items. Next, the one or more content items and the rights management key are encrypted using the generated activation key, wherein the activation key is then encrypted using the requesting 671 device public key and signed using the distributing 673 device private key, are then delivered to the requesting 671 device. Further, the requesting 671 device receives the encrypted content items and verifies source (e.g., distributor) of the content items and confirms that the content is from a valid D/R module using the distributing 673 device public key. Further, the encrypted activation key is decrypted utilizing the distributing 673 device private key and the activation key is utilized to decrypt the one or more content items. By decrypting the content file, the requesting 671 device D/R module 105 activates the rights management key and gains access to the content items.

The processes described herein for distributing content among user devices while in an offline mode may be advantageously implemented via software, hardware, firmware, or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

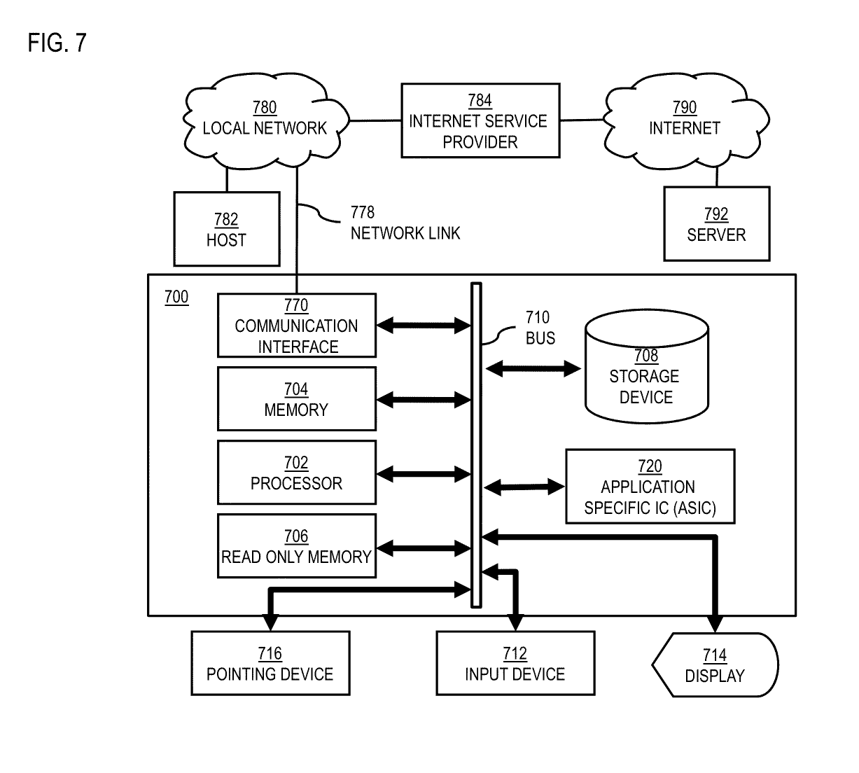

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to distribute content among user devices while in an offline mode as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of distributing content among user devices while in an offline mode.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to distributing content among user devices while in an offline mode. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for distributing content among user devices while in an offline mode. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for distributing content among user devices while in an offline mode, is provided to the bus 710 for use by the processor from an external input device 712, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 109 for distributing content among user devices while in an offline mode to the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to distribute content among user devices while in an offline mode as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of distributing content among user devices while in an offline mode.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to distribute content among user devices while in an offline mode. The memory 805 also stores the data associated with or generated by the execution of the inventive steps.

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of distributing content among user devices while in an offline mode. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of distributing content among user devices while in an offline mode. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to distribute content among user devices while in an offline mode. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
one or more requests from at least one requesting device for one or more content items associated with at least one distributing device, wherein the one or more requests are determined using local connectivity between the at least one requesting device and the at least one distributing device;
an exchange, a storage, or a combination thereof of transactional information associated with (a) the one or more requests, (b) a delivery of the one or more content items, or (c) a combination thereof of in an offline mode; and
a transmission of the transactional information to at least one server when in an online mode.

2. A method of claim 1, wherein the (1) data and/or (2) information and/or (3) at least one signal are further based, at least in part, on the following:
a discovery of the at least one requesting device, the at least one distributing device, or a combination thereof over one or more proximity communication methods.

3. A method of claim 2, wherein the (1) data and/or (2) information and/or (3) at least one signal are further based, at least in part, on the following:
a compilation of one or more catalogs of the one or more content items available from the at least one distributing device; and
a transmission of the one or more catalogs to the at least one requesting device in response to the one or more requests.

4. A method of claim 1, wherein the (1) data and/or (2) information and/or (3) at least one signal are further based, at least in part, on the following:
a processing of metadata associated with the one or more content items to determine one or more associated parties of the one or more content items; and
a processing of the transactional information to cause, at least in part, distribution of one or more credits, one or more debits, or a combination thereof among the one or more associated parties, the at least one requesting device, the at least one distributing device, or a combination thereof.

5. A method of claim 1, wherein the (1) data and/or (2) information and/or (3) at least one signal are further based, at least in part, on the following:
a processing of metadata associated with the one or more content items to determine rights management information,
wherein the transactional information, the delivery of the one or more content items, or a combination thereof are based, at least in part, on the rights management information.

6. A method of claim 5, wherein the (1) data and/or (2) information and/or (3) at least one signal are further based, at least in part, on the following:
a registration of the one or more content items with at least one content provider,
wherein the metadata, the rights management information, or a combination thereof are determined from the at least one content provider.

7. A method of claim 6, wherein the rights management information is based, at least in part, on one or more encryption schemes, one or more activation keys, or a combination thereof.

8. A method of claim 1, wherein the (1) data and/or (2) information and/or (3) at least one signal are further based, at least in part, on the following:
a ranking of the at least one distributing device based, at least in part, on a number of times that the at least one distributing device has distributed the one or more content items to the at least one requesting device, one or more other devices, or a combination thereof.

9. A method of claim 1, wherein the (1) data and/or (2) information and/or (3) at least one signal are further based, at least in part, on the following:
a transmission of the transactional information based, at least in part, on an availability of the online mode, a predetermined schedule, on demand, or a combination thereof.

10. A method of claim 1, wherein the (1) data and/or (2) information and/or (3) at least one signal are further based, at least in part, on the following:
a processing of the transactional information to determine at least one distribution path for the one or more content items.

11. An apparatus comprising:
at least one processor; and
at least one memory including computer program code for one or more programs,
the at least one memory and the computer program code configured to, with the at least one processor, cause the apparatus to perform at least the following,
determine one or more requests from at least one requesting device for one or more content items associated with at least one distributing device, wherein the one or more requests are determined using local connectivity between the at least one requesting device and the at least one distributing device;
cause, at least in part, an exchange, a storage, or a combination thereof of transactional information associated with (a) the one or more requests, (b) a delivery of the one or more content items, or (c) a combination thereof of in an offline mode; and
cause, at least in part, a transmission of the transactional information to at least one server when in an online mode.

12. An apparatus of claim 11, wherein the apparatus is further caused to:
cause, at least in part, a discovery of the at least one requesting device, the at least one distributing device, or a combination thereof over one or more proximity communication methods.

13. An apparatus of claim 12, wherein the apparatus is further caused to:
cause, at least in part, a compilation of one or more catalogs of the one or more content items available from the at least one distributing device; and
cause, at least in part, a transmission of the one or more catalogs to the at least one requesting device in response to the one or more requests.

14. An apparatus of claim 11, wherein the apparatus is further caused to:
process and/or facilitate a processing of metadata associated with the one or more content items to determine one or more associated parties of the one or more content items; and
process and/or facilitate a processing of the transactional information to cause, at least in part, distribution of one or more credits, one or more debits, or a combination thereof among the one or more associated parties, the at least one requesting device, the at least one distributing device, or a combination thereof.

15. An apparatus of claim 11, wherein the apparatus is further caused to:
process and/or facilitate a processing of metadata associated with the one or more content items to determine rights management information,
wherein the transactional information, the delivery of the one or more content items, or a combination thereof are based, at least in part, on the rights management information.

16. An apparatus of claim 15, wherein the apparatus is further caused to:
cause, at least in part, a registration of the one or more content items with at least one content provider,
wherein the metadata, the rights management information, or a combination thereof are determined from the at least one content provider.

17. An apparatus of claim 16, wherein the rights management information is based, at least in part, on one or more encryption schemes, one or more activation keys, or a combination thereof.

18. An apparatus of claim 11, wherein the apparatus is further caused to:
cause, at least in part, a ranking of the at least one distributing device based, at least in part, on a number of times that the at least one distributing device has distributed the one or more content items to the at least one requesting device, one or more other devices, or a combination thereof.

19. An apparatus of claim 11, wherein the apparatus is further caused to:
cause, at least in part, a transmission of the transactional information based, at least in part, on an availability of the online mode, a predetermined schedule, on demand, or a combination thereof.

20. An apparatus of claim 11, wherein the apparatus is further caused to:
process and/or facilitate a processing of the transactional information to determine at least one distribution path for the one or more content items.
